(19) United States
(12) Patent Application Publication
(10) Pub. No.: US 2007/0162975 A1
(43) Pub. Date: Jul. 12, 2007

(54) Efficient collection of data

(75) Inventors: Adam J. Overton, Redmond, WA (US); Alexey A. Polyakov, Sammamish, WA (US); Andrew Newman, Kirkland, WA (US); Jason Garms, Woodinville, WA (US); Ronald A. Franczyk, Kirkland, WA (US); Scott A. Field, Redmond, WA (US); Sterling M. Reasor, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microssoft Corporation, Redmond, WA (US)

(21) Appl. No.: 11/326,890

(22) Filed: Jan. 6, 2006

(51) Int. Cl. G06F 12/14

(52) U.S. Cl. 726/24

(57) ABSTRACT

Generally described, a method, software system, and computer-readable medium are provided for efficiently collecting data this useful in developing software systems to identify and protect against malware. In accordance with one embodiment, a method for collecting data to determine whether a malware is propagating in a networking environment is provided. More specifically, the method includes receiving preliminary data sets at a server computer from a plurality of client computers that describes attributes of a potential malware. Then a determination is made regarding whether secondary data is needed to implement systems for protecting against the potential malware. If secondary data is needed, the method causes the secondary data to be collected when an additional preliminary data set is received from a client computer.

### BACKGROUND

The constant progress of communication systems that connect computers, particularly the explosion of the Internet and intranet networks, has resulted in the development of a new information era. With a single personal computer, a user may obtain a connection to the Internet and have direct access to a wide range of resources, including electronic business applications that provide a wide range of information and services. Solutions have been developed for rendering and accessing a huge number of resources. However, as more computers have become interconnected through various networks such as the Internet, abuse by malicious computer users has also increased. As a result, computer systems that identify potentially unwanted software have been developed to protect computers from the growing abuse that is occurring on modem networks.

It is estimated that four out of five users have potentially unwanted software on their personal computers. Those skilled in the art and others will recognize that potentially unwanted software may become resident on a computer using a number of techniques. For example, a computer connected to the Internet may be attacked so that a vulnerability on the computer is exploited and the potentially unwanted software is delivered over the network as an information stream. These types of attacks come in many different forms including, but certainly not limited to, computer worms, denial of service attacks and the like, all of which exploit one or more computer system vulnerabilities for illegitimate purposes. Also, potentially unwanted software may become resident on a computer using social engineering techniques. For example, a user may access a resource such as a Web site and download a program from the Web site to a local computer. While the program may be described on the Web site as providing a service desirable to the user; in actuality, the program may perform actions that are malicious or simply undesirable to the user. While those skilled in the art will recognize that potentially unwanted software may take many different forms, for purposes of the present invention and for simplicity in description, all potentially unwanted software will be generally referred to hereinafter as computer malware or, more simply, malware. As described herein, computer malware includes, but is certainly not limited to, spyware, ad-ware, viruses, Trojans, worms, RootKit, or any other computer program that performs actions that are malicious or not desirable to the user.

When a malware becomes resident on a computer, the adverse results may be readably noticeable to the user, such as system devices being disabled; applications, file data, or firmware being erased or corrupted; the computer system crashing or being unable to perform normal operations. However, some malware performs actions that are covert and not readily noticeable to the user. For example, spyware typically monitors a user's computer habits, such as Internet browsing tendencies, and transmits potentially sensitive data to another location on the network. The potentially sensitive data may be used in a number of ways, such as identifying a commercial product that matches the observed tendencies of the user. Then the spyware may be used to display an advertisement to the user that promotes the identified commercial product. Since the advertisement interrupts the normal operation of the computer, the actions performed by the spyware may not be desirable to the user.

Under the present system of identifying and addressing malware, computers are susceptible to being attacked in certain circumstances. For example, there is a period of time, referred to hereafter as a vulnerability window, that exists between when a new computer malware is released on the network and when antivirus software or an operating system component may be updated to protect the computer system from the malware. As the name suggests, it is during this vulnerability window that a computer system is vulnerable, or exposed, to the new computer malware.

FIG. 1 is a block diagram of an exemplary timeline that illustrates a vulnerability window 104 with regard to a timeline 100. As shown on the timeline 100, at event 102 a malware author releases a new computer malware. As this is a new computer malware, in this example, there is neither an operating system patch nor an antivirus update available to protect vulnerable computer systems from the malware. Correspondingly, the vulnerability window 104 is opened.

At some point after the new computer malware is circulating on the network, an operating system provider and/or the antivirus software provider detects the new computer malware, as indicated by event 106. Once the computer malware is detected, the operating system and antivirus software providers may begin the process of reverse engineering the malware and creating a software update to recognize and/or protect against the computer malware. As a result of this effort, at event 108 the operating system provider and/or the antivirus software provider release an update that addresses the computer malware. Subsequently, at event 110 the update is installed on a user's computer system, thereby protecting the computer system and bringing the vulnerability window 104 to a close.

As can be seen from the examples described above, which are only representative of all of the possible scenarios in which computer malware poses security threats to a computer system, a vulnerability window 104 exists between the times that a computer malware 112 is released on a network and when a corresponding update is installed on a user's computer system. Those skilled in the art and others will recognize that the longer a vulnerability window exists, the greater the number of networked computers will be infected by the released malware. Thus, methods for quickly identifying new malware propagating on a communication network and initiating the process of creating a software update to protect against the new malware, may prevent vast numbers of networked computers from being infected.

### SUMMARY

Generally described, embodiments of the present invention are directed at efficiently collecting data this useful in developing software systems for identifying and protecting against malware. In accordance with one embodiment, a method for collecting data to determine whether a malware is propagating in a networking environment is provided. More specifically, the method includes receiving preliminary data sets at a server computer from a plurality of client computers that describes attributes of a potential malware. Then a determination is made regarding whether secondary data is needed to implement systems for protecting against the potential malware. If secondary data is needed, the method causes the secondary data to be collected when an additional preliminary data set is received from a client computer.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial depiction of an exemplary timeline that illustrates how a vulnerability window exists when a new malware is released on a communication network;

FIG. 2 is an exemplary pictorial depiction of a networking environment that includes a backend server and a plurality of client computers in which aspects of the present invention may be implemented;

FIG. 3 is an exemplary block diagram of a backend server and client computer illustrated in FIG. 2 with software components that are configured to implement aspects of the present invention;

FIG. 4 is an exemplary flow diagram that illustrates a routine for efficiently collecting data in a networking environment; and

FIG. 5 is an exemplary sample of a backend database operative to illustrate an exemplary mechanism for determining when to collect data from networked computers.

### DETAILED DESCRIPTION

Aspects of the present invention may be described in the general context of computer-executable instructions, such as program modules, being executed by a computer. Generally described, program modules include routines, programs, applications, widgets, objects, components, data structures, and the like that perform particular tasks or implement particular abstract data types. Moreover, the present invention will typically be implemented in distributed computing environments where tasks are performed by remote processing devices that are linked through a communications network. In a distributed computing environment, program modules may be located on local and/or remote computer storage media.

Embodiments of the present invention described herein are directed at efficiently collecting data that is useful in identifying and protecting against malware. In this regard, when a program (hereinafter referred to as “potential malware”) is scheduled to be added to an extensibility point on a computer associated with a user, a preliminary set of data that includes, among other things, a unique signature of the potential malware is transmitted to a server computer that is associated with a trusted entity. In any event, the preliminary set of data will typically be collected at a central location and aggregated together for the purpose of identifying “highly suspicious” potential malware. Then, when the highly suspicious potential malware is again encountered on a computer in the networking, more detailed secondary data may be collected. Among other things, the secondary data may include an actually binary or executable of the potential malware that allows developers to “reverse engineer” the potential malware. When an actual binary of the potential malware is reverse engineered, a signature that prevents the potential malware from continuing to spread on the communication network may be developed. By using this type of tiered system to collect data about programs being installed in a networking environment, the use of network resources (e.g., network bandwidth, and the like) expended in collecting data to identify new malware is minimized.

While the present invention will primarily be described in the context of collecting data for the purpose of identifying new malware released on a communication network, those skilled in the relevant art and others will recognize that the present invention is also applicable to other areas than those described. In any event, the following description first provides a description of an environment and system in which aspects of the present invention may be implemented. Then a method that implements aspects of the invention is described. The illustrative examples described herein are not intended to be exhaustive or to limit the invention to the precise forms disclosed. Similarly, any steps described herein may be interchangeable with other steps or combinations of steps in order to achieve the same result.

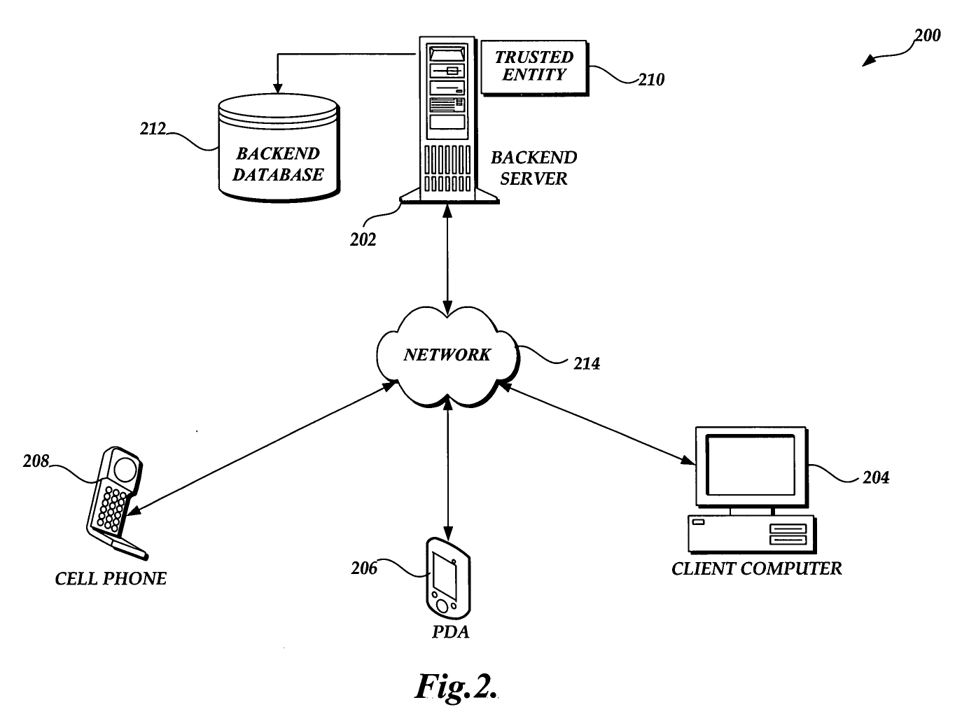

The following discussion is intended to provide a brief, general description of a networking environment 200 suitable to implement aspects of the present invention. As illustrated in FIG. 2, the networking environment 200 is comprised of a plurality of computers, namely, the backend server 202, the client computer 204, the personal digital assistant (“PDA”) 206, and the cell phone 208. The backend server 202 is shown associated with a trusted entity 210 and a backend database 212. Also, the backend server 202 is configured to communicate with the client computer 204, PDA 206, and the cell phone 208, via the network 214, which may be implemented as a Local Area Network (“LAN”), Wide Area Network (“WAN”), or the global network commonly known as the Internet. As known to those skilled in the art and others, the computers 202, 204, 206, and 208 illustrated in FIG. 2 may be configured to exchange files, commands, and other types of data over the network 214. However, since protocols for network communication such as TCP/IP are well known to those skilled in the art of computer networks, those protocols will not be described here.

For the sake of convenience, FIG. 2 illustrates a server computer, a client computer, a PDA, and a cell phone that are usable in the networking environment 200 in which complementary tasks may be performed by remote computers linked together through the communication network 214. However, those skilled in the art will appreciate that aspects of the present invention may be practiced with many other computer system configurations. For example, the present invention may be practiced with a personal computer operating in a stand-alone environment or with multiprocessor systems, minicomputers, mainframe computers, and the like. In this regard, the functions performed by the computers described herein, may be implemented by a plurality of computers. For example, while the backend server 202 is illustrated as a single computer, server-based tasks are typically implemented in a “server farm” in which multiple computers cooperate in executing necessary tasks. Moreover, in addition to the conventional computer systems illustrated in FIG. 2, those skilled in the art and others will also recognize that the present invention may be practiced on other kinds of computers, including laptop computers, tablet computers, or any device on which computer software or other digital content may be executed.

When software that performs the functions of the present invention is implemented in a networking environments, such as the networking environment 200 illustrated in FIG. 2, the software provides a way for developers to identify and efficiently collect data that describes potential malware. Through the quick and efficient collection of data that describes potential malware, developers are able to shorten the length of time needed to create software updates for identifying and protecting against malware that is propagating on a communication network. Stated differently, aspects of the present invention assist in minimizing the length of a vulnerability window in which malware is able to infect and spread among network-accessible computers.

In accordance with one embodiment, client-based software that implements aspects of the present invention is used to monitor Auto-Start Extensibility Points (“ASEPs”) on computers associated with users. Those skilled in the art and others will recognize that ASEPs refer to extensibility points that may be “hooked” to allow application programs to be auto-started without explicit user invocation. Embodiments of the present invention monitor a plurality of ASEPs to identify potential malware that will be executed as a result of changes made to an ASEP. Generally described, a potential malware that is added to an ASEP either automatically begins execution without user invocation (e.g., the WINDOWS EXPLORER® program in the MICROSOFT® WINDOWS operating system) or “hooks” into a program that is commonly executed by users (e.g., an internet Web browser program). ASEPs can be viewed in two ways: (1) as “hooks” (i.e., extensions) to existing auto-start application programs or (2) as standalone software applications that are registered as operating system auto-start extensions, such as an NT service in the MICROSOFT WINDOWS operating system, or as a daemon in UNIX-based operating system. Examples of known types of application programs that are commonly added to an ASEP include Browser Helper Objects (“BHOs”) and Layered Service Providers (“LSPs”).

When a potential malware is scheduled to be added to an ASEP on a client computer, a preliminary set of data that includes, among other things, a signature that uniquely identifies the potential malware may be transmitted to a server computer associated with a trusted entity. The preliminary set of data, in this embodiment, does not include all of the information that may be used by developers to identify and protect against malware. Instead, the preliminary set of data may be used to identify highly suspicious potential malware in which additional data should be collected. When highly suspicious potential malware is identified, the configuration of the server computer that is associated with the trusted entity is modified so that, when the highly suspicious potential malware is again encountered on a computer associated with a user, secondary data that further describes the potential malware is collected. For example, an additional set of data may include the actual binary or executable program that implements the potential malware. However, is should be well understood that aspects of the present invention allow secondary data to be obtained about any program that is encountered in the networking environment. Thus, the example of obtaining secondary data to identify malware should be construed as exemplary and not limiting.

As will be appreciated by those skilled in the art and others, FIG. 2 provides a simplified example of one networking environment 200 suitable for implementing aspects of the present invention. In other embodiments, the functions and features of the computing systems shown (e.g., the backend server 202, the client computer 204, the PDA 206, and the cell phone 208) may be implemented using a greater number of computing systems or reduced to a single computing system and thus not require network protocols for communication between combined systems.

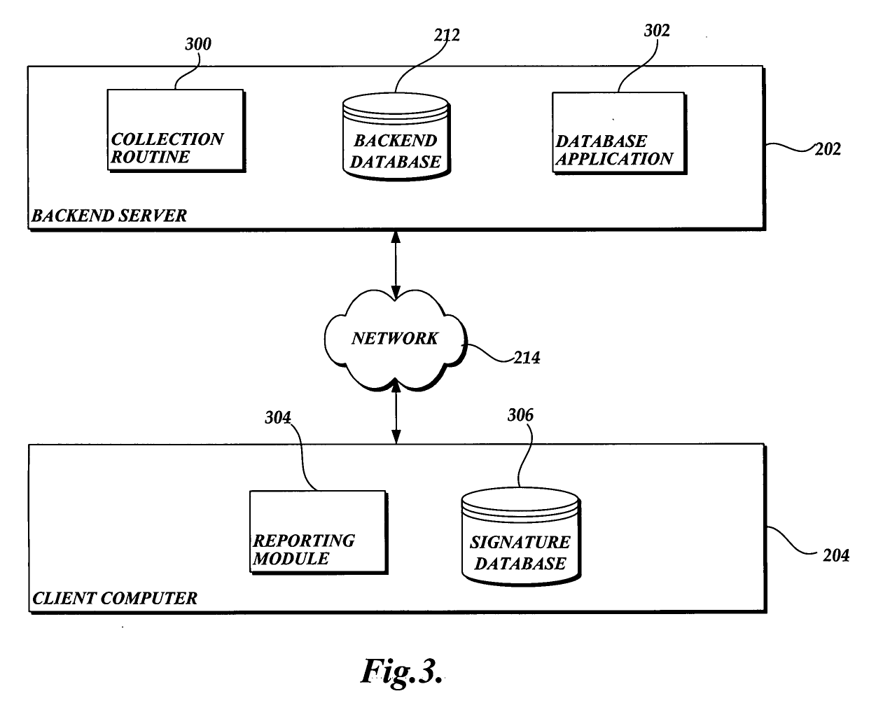

Now with reference to FIG. 3, exemplary computer architectures for the backend server 202 and the client computer 204 also depicted in FIG. 2 will be described. The exemplary computer architectures for the backend server 202 and the client computer 204 may be used to implement one or more embodiments of the present invention. Of course, those skilled in the art will appreciate that the backend server 202 and the client computer 204 may include greater or fewer components than those shown in FIG. 3. However, since those components are not important for an understanding of the present invention, they will not be described in further detail here.

With continuing reference to FIG. 3, components of the backend server 202 and the client computer 204 that are capable of implementing aspects of the present invention will be described. For ease of illustration and because it is not important for an understanding of the claimed subject matter, FIG. 3 does not show the typical components of many computers, such as a CPU, keyboard, a mouse, a printer, or other I/O devices, a display, etc. However, as illustrated in FIG. 3, the backend server 102 does include a collection routine 300, the backend database 212 (FIG. 2), and a database application 302. Moreover, the client computer 204 includes a reporting module 304 and a signature database 306 that may be included as part of any one of a number of different application programs.

In accordance with one embodiment of the present invention, a computer associated with a user maintains “client-based” software that implements aspects of the present invention. Conversely, a computer associated with the trusted entity maintains “server-based” software that implements additional aspects of the present invention. In the context of FIG. 3, the client computer 204 executes the client-based software and the backend server 202 executes the server-based software for the purpose of exchanging relevant data that describes potential malware.

As illustrated in FIG. 3, the client computer 204 includes a reporting module 304 that contains software routines and logic implemented by aspects of the present invention. Generally described, the reporting module 304 monitors ASEPs on a computer associated with a user, waiting for a potential malware to attempt to add itself to an ASEP. When the ASEP monitoring functions of the reporting module 304 are triggered, a signature of a potential malware is generated and compared to signatures that are on a “black list” of programs that are known to be malware. Moreover the signature is compared to signatures on a “white list” generated from application programs that are known to be benevolent. In this regard, the client computer 204 includes a signature database 306 that contains signatures on both the “black list” and “white list.” Those skilled in the art and others will recognize that the signature database 306 may be regularly updated using existing systems to include signatures generated from newly discovered malware or benevolent application programs.

In instances when a signature generated from a potential malware that attempts to add itself to ASEP on the client computer 204 does not match a signature maintained in the signature database 306, the reporting module 304 informs the user that an application program is being installed on the client computer 204 and that configuration changes are scheduled to be made. Moreover, in one embodiment, the user is provided with an option to block installation of the potential malware. In instances when the user does not want the potential malware installed, the scheduled installation is prevented. Conversely, in instances when the user wants the potential malware installed, the scheduled installation proceeds without interference.

When a new signature is encountered that does not match a signature in the signature database 306, the reporting module 304 generates a preliminary set of data from the client computer 204 that may be used to analyze aspects of the potential malware. In this regard, a preliminary set of data is generated that is transmitted over the network 214 to the backend server 202 by the reporting module 304 where the data is stored in the backend database 212. As described in further detail below, when the preliminary set of data is received at the backend database 212, a determination may be made that secondary data should be collected. In this instance, the reporting module 304, is also responsible for generating the secondary data and transmitting this data to the backend server 202.

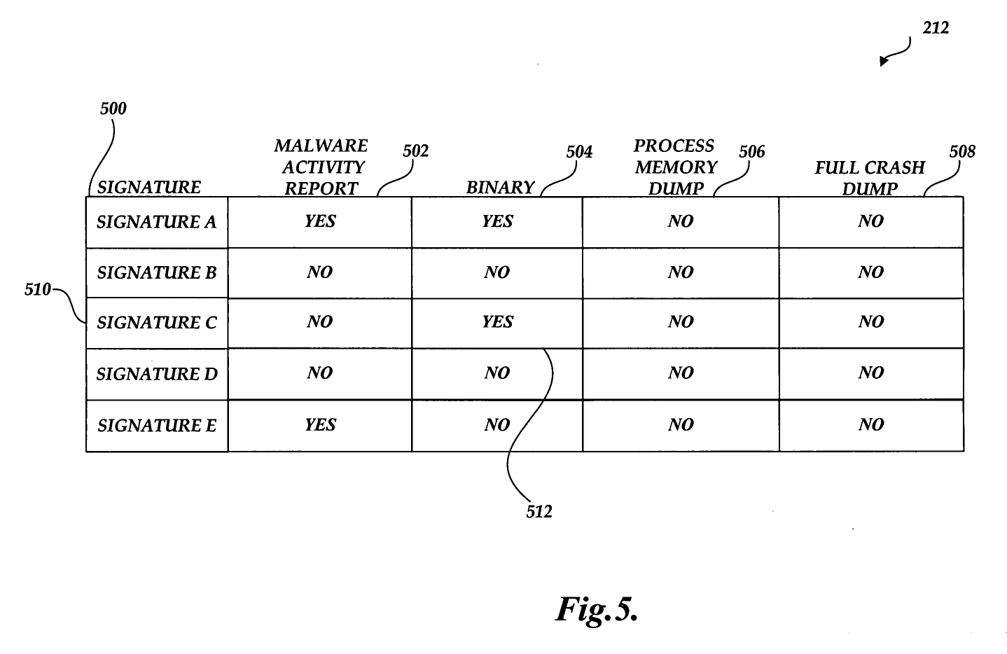

As further illustrated in FIG. 3, the backend server 202 includes a backend database 212. Since aspects of the backend database 212 will be described in detail below with reference to FIG. 5, a detailed description of these aspects of the database 212 will not be provided here. However, generally described, the backend database 212 receives data from disparate computers connected to the network 214. Moreover, the data stored in the backend database 214 may be aggregated into different “views” to assist developers in determining whether a program is malware and whether secondary data should be collected. In this regard, the backend server 202 includes a database application 302 that is configured to sort, arrange, or otherwise manipulate data in the backend database 212 to create the different “views.” For example, one “view” may be directed at identifying the number of users who allowed a certain potential malware to be installed on their computer.

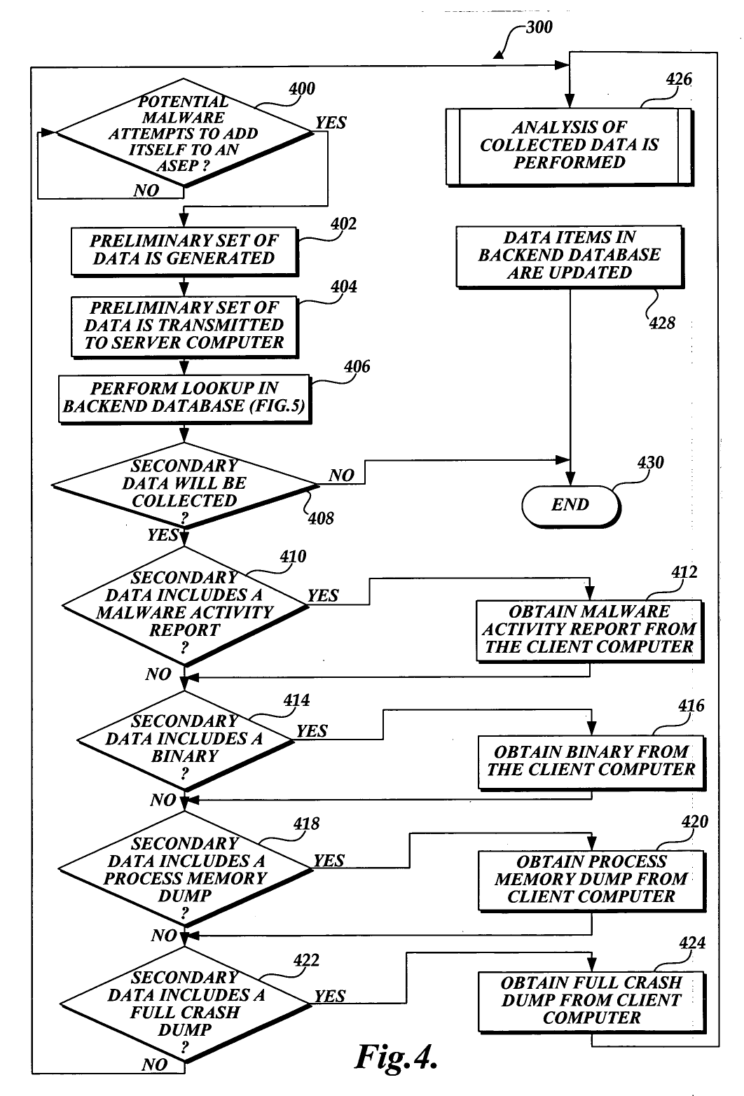

The backend server 202 illustrated in FIG. 3 includes a collection routine 300 that identifies when a potential malware is encountered in which secondary data should be collected. Since different aspects of the collection routine 300 are described below with reference to FIG. 4, a detailed description of the routine 300 will not be provided here. However, generally described, when the preliminary sets of data are obtained from a plurality of client computers that describe a potential malware, an aggregated view of the data may indicate that a highly suspicious potential malware is propagating on a communication network. For any number of reasons, developers may want to obtain secondary data that provides additional information about the potential malware. In this instance, when the potential malware is encountered again in the communication network, the collection routine 300 causes the secondary data requested that provides additional information about the potential malware to be collected.

Those skilled in the art and others will recognize that the backend server 202 and the client computer 204 illustrated in FIG. 3 are highly simplified examples that only illustrate components that are necessary for an understanding of the claimed subject matter. In actual embodiments of the present invention, the backend server 202 and the client computer 204 will have additional components that are not illustrated in FIG. 3. Thus, FIG. 3 provides only one example of component architectures for implementing aspects of the present invention and is not intended to suggest any limitation as to the scope of use or functionality of the claimed subject matter.

Now with reference to FIG. 4, an exemplary embodiment of a collection routine 300 that causes data requested by developers to be transmitted to a server computer, such as the backend server 202 (FIG. 3), will be described. As a preliminary matter, it should be well understood that some of the steps described below may be performed by client-based software that executes on a computer associated with a user. For example, blocks 400-404 will typically be performed by the reporting module 304 (FIG. 3), which executes on a client computer. However, since these steps are important for an understanding of the steps that are performed on a server computer, they will be briefly described with reference to FIG. 4.

As illustrated in FIG. 4, at decision block 400, aspects of the invention wait until a potential malware attempts to add itself to an ASEP on a client computer. Those skilled in the art and others will recognize that the functionality of modem computer systems (e.g., operating systems, application programs, etc.) may be extended by other software systems. As mentioned previously, when the functionality of an operating system or application program is extended by other software systems, changes are made to the configuration of a computer so that program code is executed automatically without being invoked by the user. As a result, a potential malware may monitor the activities of the user or regularly perform actions that users find undesirable. Typically, modifications are made to one or more ASEPs when a potential malware is scheduled to be installed on a computer. As described previously, aspects of the present invention monitor a plurality of ASEPs to identify instances when potential malware is scheduled to be added to an ASEP on a computer.

At block 402, a preliminary set of data is generated on a client computer in which a potential malware attempted to add itself to an ASEP, at block 400. The preliminary set of data is used to catalog potential malware that are encountered on computers connected to a communication network. Moreover, as mentioned previously, the data generated on a client computer may be aggregated with data that is received from different computers to determine whether an application program that is being encountered on client computers is malware. In this regard, the preliminary set of data generated at block 402 includes, but is not limited to, a signature of the potential malware, file metadata, configuration data, and run-time attributes that identify the state of the computer. Moreover, the preliminary set of data includes an indicator or “vote” regarding whether the user allowed the potential malware to be installed on their computer. It should be well understood that the preliminary set of data generated at block 402 contains a minimal amount of information that consumes a small amount of network resources when transmitted to a remote computer.

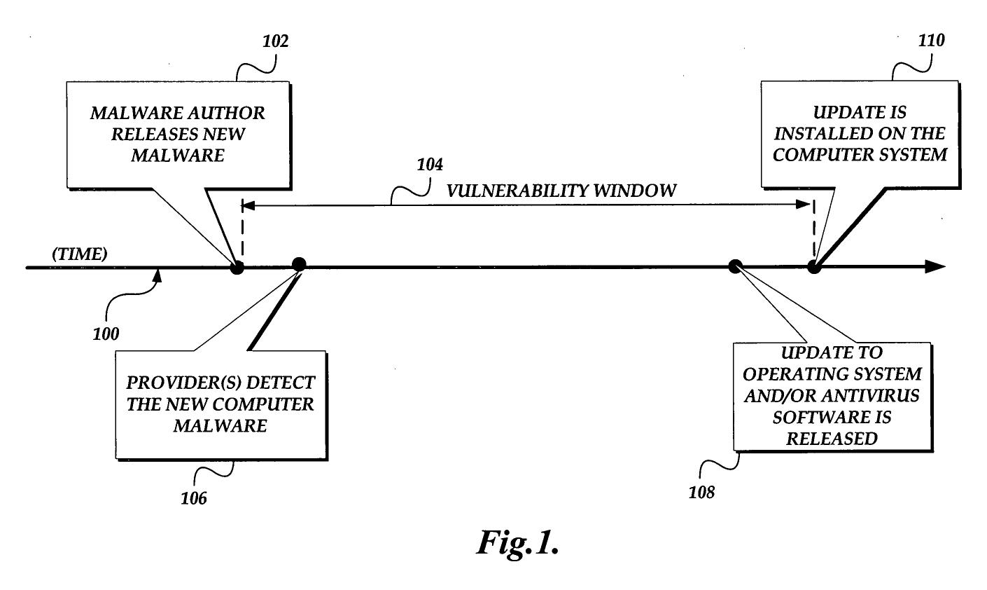

At block 404, the preliminary set of data generated at block 402 is transmitted to a computer associated with a trusted entity. For example, data generated from a computer associated with a user (e.g., the client computer 204) may be transmitted over a network connection to the backend server 202 (FIG. 1) and stored in the backend database 212. However, since transmitting a set of data over a network connection for storage in a database may be performed using techniques that are generally known in the art, further description of these techniques will not be provided here.

As further illustrated in FIG. 4, at block 406, the collection routine 300 causes a lookup to be performed in the backend database 212 for a signature that matches the signature generated from the potential malware. As mentioned previously, a signature that uniquely identifies a potential malware is obtained, at block 404, from a client computer. For example, data in a file and/or data that describes attributes of a file, such as file metadata, may be processed with a hash function that converts the data into a unique signature. In this example, a characteristic subset of a file may be identified and processed using the Message-Digest algorithm 5 (“MD5”) hashing algorithm to generate the signature. In any event, at block 406, a lookup is performed to determine whether a matching signature for the potential malware is already contained in the backend database 212. In this regard, the database application 302 (FIG. 3) may be used to sort data in the backend database 212 to perform the lookup for the appropriate signature.

Now with reference to FIG. 5, an exemplary sample of the backend database 212 in which a lookup is performed, at block 406, will be described. As illustrated in FIG. 5, in this embodiment, the backend database 212 includes five columns that are entitled “SIGNATURE” 500, “MALWARE ACTIVITY REPORT” 502, “BINARY” 504, “PROCESS MEMORY DUMP” 506, and “FULL CRASH DUMP” 508. As described in further detail below, an analysis may be performed on the preliminary data sets obtained from one or more client computers. The analysis may reveal that a highly suspicious potential malware is propagating on a communication network. In response, developers may want to obtain more detailed secondary data about the highly suspicious potential malware. Aspects of the present invention allow developers to update the backend database 212 to reflect that secondary data should be collected when the highly suspicious potential malware is encountered again. For example, as illustrated in the exemplary sample of the backend database 212 depicted in FIG. 5, a plurality of data items are associated with each signature in the backend database 212. For example, in the “BINARY” 504 column that is associated with row 510, a data item represented with the value “yes” was entered into the field 512. In this example, the value entered into the field 512 indicates that if a signature is identified that matches the signature represented in a row 510, the binary of the potential malware identified by the signature should be obtained and stored in the backend database 212. While an exemplary sample of the backend database 212 has been illustrated in FIG. 5, those skilled in the art and others will recognize that the backend database 212 may be configured to store data items about other types of secondary data. Thus, the exemplary sample of the backend database 212 illustrated in FIG. 5, should be construed as exemplary and not limiting.

Returning to FIG. 4, at decision block 408, the collection routine 300 determines whether the configuration of the backend database 212 indicates that secondary data should be collected from the client computer that transmitted the preliminary set of data to the server computer, at block 404. As described previously, the backend database 212 includes data items that may be set to indicate that certain types of secondary data should be collected. Thus, at decision block 408, a determination whether any entries in the backend database 212 indicate that secondary data should be collected from the potential malware that attempted to add itself to an ASEP at block 400 is made. If secondary data will not be collected, the collection routine 300 proceeds to block 430, where it terminates. Conversely, if secondary data will be collected, the collection routine 300 proceeds to block 410.

At decision block 410, the collection routine 300 determines whether the secondary data that will be collected includes a “malware activity report.” In one embodiment, if the “MALWARE ACTIVITY REPORT” 502 column of the backend database 212 contains a value which indicates that a malware activity report should be collected, the collection routine 300 proceeds to block 412. Conversely, if the appropriate value in the backend database 212 does not indicate that a malware activity report should be collected, the collection routine 300 proceeds to block 414.

At block 412, a malware activity report is obtained from the client computer that transmitted the preliminary set of data to the trusted entity at block 404. As mentioned previously, client-based software that is implemented by aspects of the present invention may be included in anti-malware software that is installed on a client computer. Those skilled in the art and others will recognize that some anti-malware software systems are configured to produce reports that describe behaviors observed on a computer that may be characteristic of malware. For example, software systems exist that record suspicious activities such as excess network activity, use of potentially dangerous resources, and the like. In any event, at block 412, data is transmitted to the client computer that indicates a malware activity report was requested. In response, software on the client computer causes the malware activity report to be transmitted to a server computer that is associated with a trusted entity.

At decision block 414, the collection routine 300 determines whether the secondary data that will be collected is a binary or executable that implements the potential malware. In one embodiment, if the “BINARY” 502 column of the backend database 212 contains a value which indicates that a binary of the appropriate potential malware should be collected, the collection routine 300 proceeds to block 416. Conversely, if the appropriate value in the backend database 212 does not indicate that a binary should be collected, the collection routine 300 proceeds to block 418.

At block 416, a binary or executable of the potential malware is obtained from the client computer that transmitted the preliminary set of data to the trusted entity at block 404. Those skilled in the art and others will recognize that each program capable of being executed on a computer may be represented in a binary format. Typically, anti-malware software performs a scan for malware by searching binary file(s) that implement the functionality of the potential malware. Thus, a binary that implements the potential malware is readily accessible from a client computer. In any event, at block 416, data is transmitted to the client computer that indicates a binary of the potential malware was requested. In response, software on the client computer causes one or more binary file(s) that implement the potential malware to be transmitted to a server computer associated with the trusted entity.

At decision block 418, the collection routine 300 determines whether the secondary data that will be collected is a memory dump of the current process. In one embodiment, if the “PROCESS MEMORY DUMP” 506, column of the backend database 212 contains a value which indicates that a memory dump of the current process associated with the potential malware should be collected, the collection routine 300 proceeds to block 420. Conversely, if the appropriate entry in the backend database 212 does not indicate that a memory dump of the current process should be collected, the collection routine 300 proceeds to block 422.

At block 420, a memory dump of the current process is obtained from the client computer and transmitted to a computer associated with a trusted entity. Those skilled in the art and others will recognize that a program, or component of a program, that is scheduled to be executed by a CPU on a computer is referred to as “process.” Moreover, multitasking between different processes may be performed by allocating time slices to individual processes and performing a context switch to a subsequently scheduled process when the time slice of an executing process expires. In any event, at block 416, an indicator is transmitted to the client computer that indicates a memory dump of the current process was requested. In response, software on the client computer causes the memory dump to be generated and transmitted to a server computer that is associated with the trusted entity.

At decision block 422, the collection routine 300 determines whether the secondary data that will be collected is a full crash dump. In one embodiment, if the “FULL CRASH DUMP” 508, column of the backend database 212 contains a value which indicates that a full crash dump should be collected, the collection routine 300 proceeds to block or 424. Conversely, if the appropriate entry in the backend database 212 does not indicate that a full crash dump should be collected, the collection routine 300 proceeds to block 426.

At block 424, a full crash dump that contains all the contents of physical memory is obtained from the client computer that transmitted the preliminary set of data to the trusted entity at block 404. Those skilled in the art and others will recognize that software systems exist for creating a full crash dump. For example, in some types of systems a crash dump is automatically generated when an error occurs in a computer. In these types of systems, developers use the data contained in the crash dump to identify the source of the error. Those skilled in the art and others will recognize that a full crash includes all the contents of physical memory and data that describes the state of the computer. As a result, with a full crash dump developers are able to use programs designed for de-bugging to perform an analysis of a potential malware. In any event, at block 424, an indicator is transmitted to the client computer that indicates a full crash dump was requested. In response, software on the client computer causes the full crash dump to be generated and transmitted to a server computer that is associated with the trusted entity.

As further illustrated in FIG. 4, at block 426, an analysis of the data collected that describes the potential malware is performed. Experienced software developers may use a variety of data to determine whether potential malware encountered on computers in a communication network performs malicious acts. Also, developers may need certain data to develop systems for identifying and preventing a malware from infecting additional computers. As mentioned previously, aspects of the present invention assist developers in collecting this type of data. In some instances, a program may be identified as malware through the aggregation of the preliminary data sets obtained from a plurality of client computers. For example, as mentioned previously with reference to FIG. 3, aspects of the present invention allow developers to create different “views” of data. In this regard, one “view” may be directed at identifying the number of users who allowed a potential malware to be installed on their computer. In this instance, if 99% of users did not allow a potential malware to be installed, a strong heuristic indicator exists that the program is malware. However, even in this instance, developers may want to obtain secondary data to confirm that the program is actually malware or to create a software update to identify instances of the malware. In any event, the analysis performed at block 426 may reveal that secondary data would be helpful in identifying and/or combating the spread of a malware.

At block 428, data items in the backend database 212 are updated to reflect that secondary data that is associated with a potential malware should be collected. As mentioned previously, when a signature that matches a potential malware is identified, a lookup is performed in the backend database 212. In this regard, a field in the backend database 212 may indicate that certain types of secondary data that is associated with a potential malware should be collected. Thus, after developers perform an analysis of the data that describes a potential malware, at block 426, the backend database 212 may be updated to reflect that additional data should be collected. For example, as mentioned previously, the data collected in the backend database 212 may indicate that a high percentage of users are preventing a program from being installed on their computer. Based on this type of information, developers may conclude that the program is malware. In this instance, to create a software update capable of removing the malware from a user's computer, developers may want to collect the actual “binary” program so that the malware may be reverse engineered. In order to obtain the “binary” program, the appropriate field in the backend database 212 may be updated to reflect that this secondary data is being requested. Then the collection routine 300 proceeds to block 430, where it terminates.

While illustrative embodiments have been illustrated and described, it will be appreciated that various changes can be made therein without departing from the spirit and scope of the invention.

The embodiments of the invention in which an exclusive property or privilege is claimed are defined as follows:

1. In a computer networking environment that includes a server computer and a plurality of client computers, a method of efficiently collecting data at the server computer from the plurality of client computers to identify a malware that is propagating in the communication network, the method comprising:
(a) receiving preliminary data sets at the server computer from the plurality of client computers;
(b) determining whether secondary data that describes the potential malware is needed to develop systems to protect against malware; and
(c) if secondary data is needed to develop systems to protect against malware, obtaining the secondary data when an additional preliminary data set is received from a client computer.

2. The method as recited in claim 1, wherein receiving the preliminary data sets includes:
(a) monitoring autostart extensibility points on a client computer;
(b) causing a preliminary data set to be generated when the potential malware attempts to modify the configuration of an autostart extensibility point on the client computer; and
(c) causing the preliminary data set to be transmitted to the server computer.

3. The method as recited in claim 1, wherein a preliminary data set that is transmitted to the server computer includes a signature that uniquely identifies the potential malware; and
wherein the signature is generated using a hash function.

4. The method as recited in claim 1, wherein a preliminary data set that is transmitted to the server computer includes an indicator of whether the potential malware was installed on the client computer by the user.

5. The method as recited in claim 1, wherein the preliminary data sets are aggregated together in a database; and
wherein the server computer includes a database application that is configured to sort the preliminary data sets.

6. The method as recited in claim 1, wherein determining whether secondary data that describes the potential malware is needed to develop systems to protect against malware includes:
(a) receiving a signature that uniquely identifies the potential malware; and
(b) performing a lookup in a database to identify a matching signature.

7. The method as recited in claim 6, further comprising if a matching signature is identified, determining whether a data item associated with the matching signature indicates that secondary data is being requested.

8. The method as recited in claim 1, wherein the secondary data obtained is an anti-malware activity report that records events observed on the client computer that may be characteristic of malware.

9. The method as recited in claim 1, wherein the secondary data obtained is a binary of the potential malware that contains executable program code.

10. The method as recited in claim 1, wherein the secondary data obtained is a memory dump of the current process on the client computer.

11. The method as recited in claim 1, wherein secondary data obtained is a crash dump that contains all of the data in physical memory on the client computer.

12. A computer-readable medium containing computer-readable instructions that when executed in a computer networking environment that includes a server computer and a client computer, performs a method of reporting data that describes a potential malware encountered on the client computer to the server computer, the method comprising:
(a) when the potential malware is identified on the client computer:
(i) obtaining a preliminary data set that contains attributes associated with the potential malware; and
(ii) transmitting the preliminary data set to the server computer;
(b) if an indicator is received from the server computer that indicates secondary data is requested:
(i) obtaining the secondary data; and
(ii) transmitting the secondary data to the server computer.

13. The computer-readable medium as recited in claim 12, wherein obtaining the preliminary data set that contains attributes associated with the potential malware occurs when the potential malware attempts to modify the configuration of an autostart extensibility point on the client computer.

14. The computer-readable medium as recited in claim 12, wherein obtaining the preliminary data set that contains attributes associated with the potential malware occurs when a signature of the potential malware does not match a signature on a black list or a white list of known signatures.

15. The computer-readable medium as recited in claim 12, wherein the preliminary data set includes a signature that uniquely identifies the potential malware; and
wherein the signature is created using a hash function.

16. The computer-readable medium as recited in claim 15, wherein the indicator is received when a database lookup is performed on the server computer for the signature included in the preliminary data set; and
wherein a matching signature is identified in the database that is associated with a data item that identifies the requested secondary data.

17. In a computer networking environment that includes a server computer and a client computer, a software system for collecting data to determine whether a program encountered on the client computer is malware, the software system comprising:
(a) a reporting module on the client computer operative to provide data to the server computer, including:
(i) a preliminary data set that identifies attributes of the potential malware; and
(ii) secondary data that is requested by the collection routine;
(b) a collection routine on the server computer operative to:
(i) receive the preliminary data set from the client computer;
(ii) make a determination whether the backend database contains data that indicates secondary data should be collected; and
(iii) if a determination is made that secondary data should be collected, issue a request for the secondary data to the reporting module on the client computer; and
(c) a backend database on the server computer operative to store data including data that identifies secondary data that should be collected.

18. The software system as recited in claim 17, further comprising a database application operative to sort data that is stored in the backend database.

19. The software system as recited in claim 17, further comprising a signature database operative to store a black list and white list of signatures that are used by the reporting module to determine whether to send a preliminary data set to the server computer.

20. The software system as recited in claim 17, wherein the secondary data collected by the collection routine includes:
(a) an anti-malware activity report that records events observed on the client computer that may be characteristic of malware;
(b) a binary of the potential malware that contains executable program code;
(c) a memory dump of the current process on the client computer; and
(d) a crash dump that contains all of the data in physical memory on the client computer.
